(19) United States
(12) Patent Application Publication
(10) Pub. No.: US 2005/0055235 A1
(43) Pub. Date: Mar. 10, 2005

(54) Program control apparatus and program control method

(75) Inventors: Atsushi Mizuki, Chiyoda-ku (JP); Goro Kunito, Chiyoda-ku (JP); Kenji Sakamoto, Chiyoda-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc., Tokyo (JP)

(21) Appl. No.: 10/932,122

(22) Filed: Sep. 2, 2004

(30) Foreign Application Priority Data
Sep. 8, 2003 (JP) 2003-315822

(51) Int. Cl. G06F 17/60

(52) U.S. Cl. 705/1

(57) ABSTRACT

A program control apparatus 10 is provided with an ID class determiner 12 for determining whether a tag ID read by a tag reader 100 is a service ID to specify a service, or an attribute ID to specify an attribute of an article; and a program controller 14 so configured that when the ID class determiner 12 determines that the tag ID read by the tag reader 100 is a service ID, the program controller 14 runs a program associated with the service ID and that when the ID class determiner 12 determines that the tag ID read by the tag reader 100 is an attribute ID, the program controller 14 notifies a running program of attribute information associated with the attribute ID, to change the behavior of the running program according to the attribute information.

### BACKGROUND OF THE INVENTION

1. Field of the Invention

The present invention relates to a program control apparatus and a program control method and, more particularly, to a program control apparatus and a program control method making use of a tag ID read by a tag reader.

2. Related Background Art

In recent years, various information processing technologies making use of ID tags (also called wireless IC tags, RFID tags, etc.) have actively been proposed and studied. For example, Patent Document 1 below discloses a technology of using a tag reader to read tag IDs from respective ID tags, and running a specific program when the combination of tag IDs thus read is a specific combination preliminarily determined. This technology can be applied, for example, to an earthenware restoration game or the like. Specifically, ID tags are attached to a number of respective earthenware pieces, the tag reader is used to read tag IDs from ID tags attached to a plurality of earthenware pieces collected by a user, and, when the combination of tag IDs read is a combination of IDs necessary and sufficient for construction of a specific earthenware vessel, an explanation program for the earthenware vessel is run as a correct answer process.

[Patent Document 1] Japanese Patent Application Laid-Open No. 2002-288602

### SUMMARY OF THE INVENTION

The above-described conventional technology is the program control technology effective in limited situations, as in the case of provision of the earthenware restoration game using the limited number of earthenware pieces. However, since the above conventional program control technology runs the specific program when the combination of tag IDs read is the predetermined specific combination, it has the problem that it is incapable of performing flexible program control according to variation in surrounding circumstances. Specifically, for example, let us suppose that a tag reader reads a specific tag ID and that a specific program associated with the specific tag ID is running. Then suppose that the surrounding circumstances vary and that the tag reader reads another tag ID. In this case, the aforementioned conventional program control technology is unable to change the behavior of the specific program according to a class of the other tag ID (in other words, according to variation in surrounding circumstances).

An object of the present invention is, therefore, to solve the above problem and to provide a program control apparatus and a program control method capable of performing flexible program control according to variation in surrounding circumstances, by use of ID tags.

In order to achieve the above object, a program control apparatus of the present invention comprises ID class determining means for determining whether a tag ID read by a tag reader is a service ID to specify a service, or an attribute ID to specify an attribute of an article; and program controlling means for, when the ID class determining means determines that the tag ID read by the tag reader is a service ID, running a program associated with the service ID and for, when the ID class determining means determines that the tag ID read by the tag reader is an attribute ID, notifying a running program of attribute information associated with the attribute ID, to change behavior of the running program according to the attribute information.

In order to achieve the above object, a program control method of the present invention comprises an ID class determining step wherein ID class determining means determines whether a tag ID read by a tag reader is a service ID to specify a service, or an attribute ID to specify an attribute of an article; a program running step wherein, when it is determined in the ID class determining step that the tag ID read by the tag reader is a service ID, program controlling means runs a program associated with the service ID; and a program behavior changing step wherein, when it is determined in the ID class determining step that the tag ID read by the tag reader is an attribute ID, the program controlling means notifies a running program of attribute information associated with the attribute ID, to change behavior of the running program according to the attribute information.

It is determined whether a tag ID read by the tag reader is a service ID to specify a service, or an attribute ID to specify an attribute of an article; when the tag ID is determined to be a service ID, a program associated with the service ID is run; when the tag ID is determined to be an attribute ID, a running program is notified of attribute information associated with the attribute ID and the behavior of the running program is changed according to the attribute information; this configuration makes it feasible to change the behavior of the running program according to the attribute information of the tag ID read as a result of variation in surrounding circumstances by the tag reader.

The program control apparatus of the present invention is preferably constructed in a configuration further comprising an ID class database storing tag IDs and ID classes in association with each other, wherein the ID class determining means refers to the ID class database to determine whether a tag ID read by the tag reader is a service ID to specify a service, or an attribute ID to specify an attribute of an article.

When the ID class database is referred to in order to determine whether the tag ID read by the tag reader is a service ID or an attribute ID, it becomes easier to perform the determination on whether a service ID or an attribute ID, and the management.

The program control apparatus of the present invention is also preferably constructed in a configuration further comprising a program database storing service IDs and programs in association with each other, wherein the program controlling means refers to the program database to run the program associated with the service ID.

When the program database is referred to in order to run a program associated with the service ID, it becomes easier to select a program to be run.

The program control apparatus of the present invention is also preferably constructed in a configuration further comprising an attribute database storing attribute IDs and attributes of articles in association with each other, wherein the program controlling means refers to the attribute database to notify the running program of the attribute information associated with the attribute ID, to change the behavior of the program according to the attribute information.

When the attribute database is referred to in order to notify the running program of the attribute information associated with the attribute ID to change the behavior of the program according to the attribute information, it becomes feasible to readily change the relationship between the attribute information and the behavior of the program.

The program control apparatus and program control method of the present invention are configured to determine whether a tag ID read by the tag reader is a service ID to specify a service, or an attribute ID to specify an attribute of an article, to, when the tag ID is determined to be a service ID, run a program associated with the service ID, and to, when the tag ID is determined to be an attribute ID, notify a running program of attribute information associated with the attribute ID, to change the behavior of the running program according to the attribute information. Therefore, it becomes feasible to change the behavior of the running program according to the attribute information of the ID read as a result of variation in surrounding circumstances by the tag reader. As a result, it is feasible to perform flexible program control according to variation in surrounding circumstances, by use of ID tags.

### BRIEF DESCRIPTION OF THE DRAWINGS

FIG. 1 is a configuration diagram of a program control apparatus.

FIG. 2 is a configuration diagram of an ID class database.

FIG. 3 is a configuration diagram of a program database.

FIG. 4 is a configuration diagram of an attribute database.

FIG. 5 is a flowchart showing the operation of the program control apparatus.

### DESCRIPTION OF THE PREFERRED EMBODIMENTS

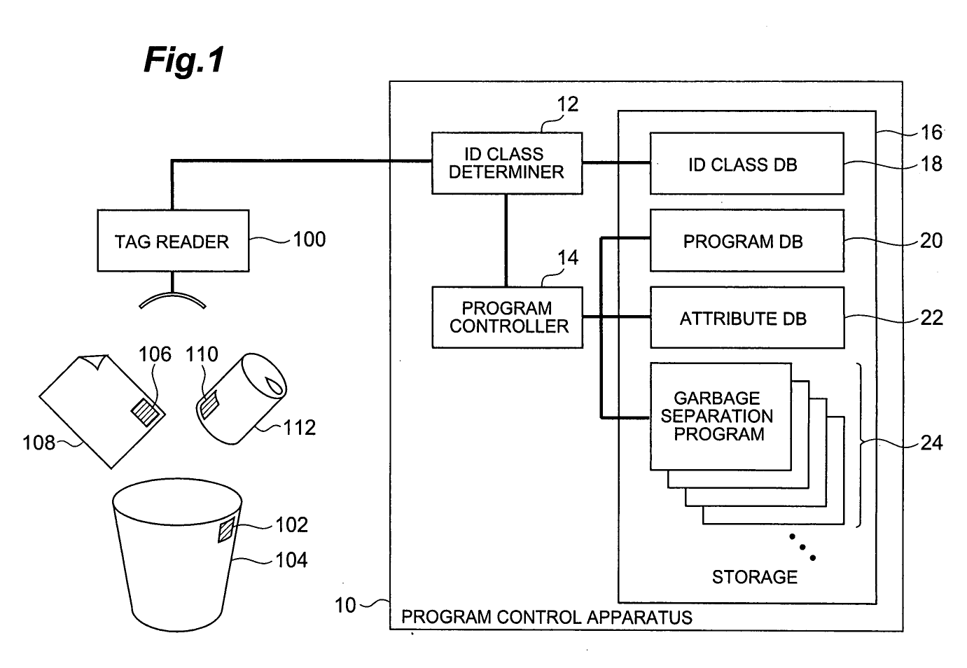

Embodiments of the present invention will be described below in detail with reference to the drawings. First, a configuration of a program control apparatus according to the present embodiment will be described. FIG. 1 is a configuration diagram of the program control apparatus according to the present embodiment.

The program control apparatus 10 according to the present embodiment, as shown in FIG. 1, is comprised of an ID class determiner 12, a program controller 14, and a storage 16. The program control apparatus 10 is physically constructed as a computer system provided with a CPU (central processing unit), memories, input apparatus such as a mouse and a keyboard, a monitor such as a display, a storage device such as a hard disk, a radio communication unit for wireless data communication with external equipment, and so on, and is connected through I/O to a tag reader 100. Each of the components will be described below in detail.

The storage 16 stores an ID class database 18, a program database 20, an attribute database 22, and a plurality of programs (e.g., “garbage separation program”) 24.

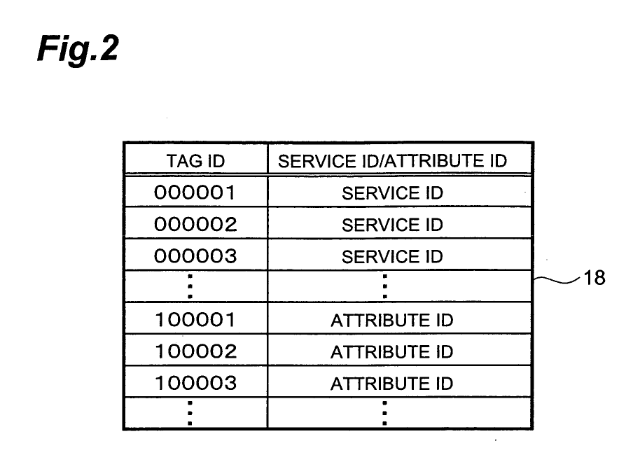

FIG. 2 is a configuration diagram of the ID class database 18. In the ID class database 18, tag IDs and ID classes are stored in association with each other. Here the ID classes include a service ID to specify a service, and an attribute ID to specify an attribute of an article. It is seen from the example of FIG. 2 that tag IDs “000001,” “000002,” and “000003” are service IDs, and tag IDs “100001,” “100002,” and “100003” are attribute IDs.

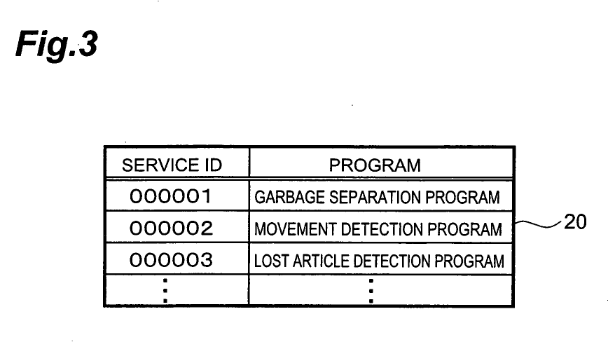

FIG. 3 is a configuration diagram of the program database 20. In the program database 20, service IDs and programs (more precisely, pointers of storage locations where the program bodies are stored) are stored in association with each other. In the example of FIG. 3, the service IDs “000001,” “000002,” and “000003” are associated with the programs of “garbage separation program,” “movement detection program,” and “lost article detection program,” respectively. In this connection, one service ID may be associated with a plurality of programs. For example, the service ID “000001” may be associated with both the program of “garbage separation program” and the program of “garbage collection date notification program.”

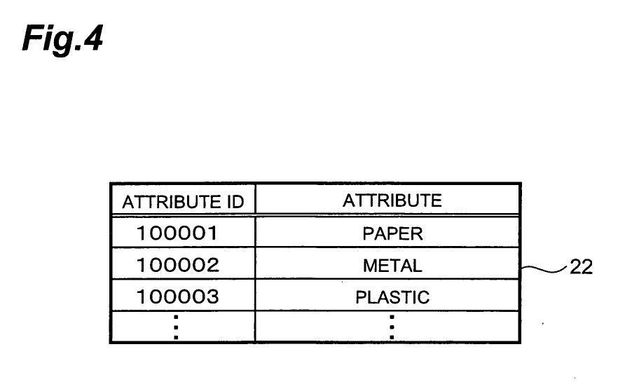

FIG. 4 is a configuration diagram of the attribute database 22. In the attribute database 22, attribute IDs and attributes of articles are stored in association with each other. In the example of FIG. 3, the attribute IDs “100001,” “100002,” and “100003” are associated with the attributes of “paper,” “metal,” and “plastic,” respectively. The attribute IDs and the attributes do not necessarily have to be in one-to-one relation. For example, the attribute ID “100004” may be further associated with the attribute of “paper.” In addition, one attribute ID may be associated with a plurality of attributes. For example, the attribute ID “100001” may be associated with both the attribute of “paper” and the attribute of “disposable.”

Each of the programs 24 is a computer program for letting a computer execute a specific function. Here, particularly, each of the programs 24 is a program configured to receive input of information from the outside during running thereof and to change its behavior according to the input information. For example, the “garbage separation program” is configured as follows: during running thereof, it receives input information from the outside on a periodic basis or at every occurrence of a specific event; if the input information from the outside is the attribute information of “paper,” it performs a voice information output process of outputting voice information “Thank you for your cooperation in collection of garbage by type”; and it also performs a process of transmitting a control signal for opening a lid, to an automatic lid opening/closing mechanism provided in a garbage box. On the other hand, the “garbage separation program” also acts as follows: if the input information from the outside is attribute information except for “paper,” it performs a voice information output process of outputting voice information “This garbage box is available for paper only”; and it also performs a process of transmitting a control signal for closing the lid, to the automatic lid opening/closing mechanism provided in the garbage box.

The ID class determiner 12 refers to the ID class database 18 stored in the storage 16 to determine whether a tag ID read by the tag reader 100 is a service ID to specify a service, or an attribute ID to specify an attribute of an article. More specifically, the ID class determiner 12 receives input of a tag ID (or a set of tag IDs) read on a periodic basis by the tag reader 100. When the ID class determiner 12 receives the input of the tag ID, it performs a process of comparing a tag ID (or a set of tag IDs) received as preceding input, with the tag ID (or set of tag IDs) received as current input. If the comparison between the current input tag ID and the preceding input tag ID detects a new tag ID in the current input, the ID class determiner 12 refers to the ID class database 18 stored in the storage 16, using the tag ID as a key, to determine whether the tag ID is a service ID or an attribute ID.

For example, as shown in FIG. 1, let us suppose that a garbage box 104 with ID tag 102 (tag ID: 000001), a sheet of paper 108 with ID tag 106 (tag ID: 100001), and an empty can 112 with ID tag 110 (tag ID: 100002) move into the detection range of the tag reader 100. The tag reader 100 reads the tag ID “000001” of the ID tag 102 attached to the garbage box 104 and feeds the tag ID to the ID class determiner 12, and then the ID class determiner 12 refers to the ID class database 18, using the tag ID as a key, to determine that the tag ID is a service ID. Similarly, the tag reader 100 reads the tag ID “100001” of the ID tag 106 attached to the sheet of paper 108 and feeds the tag ID to the ID class determiner 12, and then the ID class determiner 12 refers to the ID class database 18, using the tag ID as a key, to determine that the tag ID is an attribute ID. Likewise, the tag reader 100 reads the tag ID “100002” of the ID tag 110 attached to the empty can 112 and feeds the tag ID to the ID class determiner 12, and then the ID class determiner 12 refers to the ID class database 18, using the tag ID as a key, to determine that the tag ID is an attribute ID. The ID class determiner 12 sends the determination result to the program controller 14.

When the ID class determiner 12 determines that a tag ID read by the tag reader 100 is a service ID, the program controller 14 refers to the program database 20 stored in the storage 16, to run a program associated with the service ID. When the ID class determiner 12 determines that a tag ID read by the tag reader 100 is an attribute ID, the program controller 14 refers to the attribute database 22 stored in the storage 16, to notify a running program of attribute information associated with the attribute ID, to change the behavior of the running program according to the attribute information.

For example, in the case where the tag reader 100 reads the tag ID “000001” of the ID tag 102 attached to the garbage box 104 and where the ID class determiner 12 determines that the tag ID is a service ID, the program controller 14 refers to the program database 20 stored in the storage 16, using the service ID as a key, to retrieve the “garbage separation program” associated with the service ID “000001,” from the storage 24 and to run the program. Here the “garbage separation program” receives input from the outside on a periodic basis or at every occurrence of a specific event during the running thereof.

In the case where the tag reader 100 reads the tag ID “100001” of the ID tag 106 attached to the sheet of paper 108 and where the ID class determiner 12 determines that the tag ID is an attribute ID, the program controller 14 refers to the attribute database 22 stored in the storage 16, using the attribute ID as a key, to retrieve the attribute information “paper” associated with the attribute ID “100001.” The program controller 14 further notifies the running “garbage separation program” of the attribute information “paper” to change the behavior of the running “garbage separation program.” Namely, the running “garbage separation program” receives the input of the attribute information “paper” from the outside, and performs the voice information output process of outputting the voice information “Thank you for your cooperation in collection of garbage by type” and the process of transmitting the control signal for opening of the lid, to the automatic lid opening/closing mechanism provided in the garbage box.

In the case where the tag reader 100 reads the tag ID “100002” of the ID tag 110 attached to the empty can 112 and where the ID class determiner 12 determines that the tag ID is an attribute ID, the program controller 14 refers to the attribute database 22 stored in the storage 16, using the attribute ID as a key, to retrieve the attribute information “metal” associated with the attribute ID “100002.” The program controller 14 further notifies the running “garbage separation program” of the attribute information “metal” to change the behavior of the running “garbage separation program.” Namely, the running “garbage separation program” receives the input of the attribute information “metal” from the outside, and performs the voice information output process of outputting the voice information “This garbage box is available for paper only” and the process of transmitting the control signal for closing of the lid, to the automatic lid opening/closing mechanism provided in the garbage box.

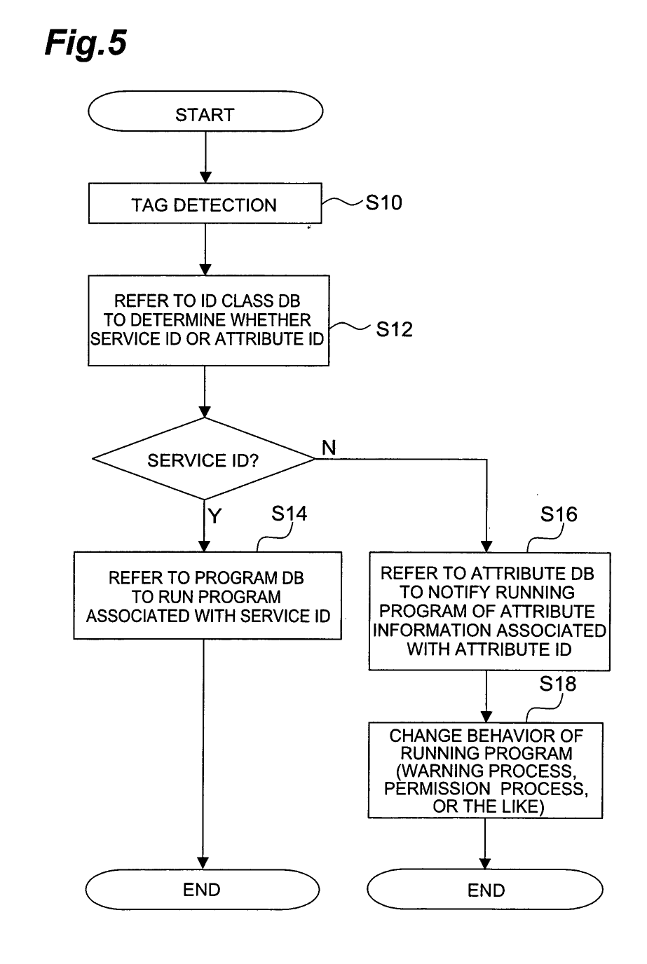

Subsequently, the operation of the program control apparatus according to the present embodiment will be described, together with a program control method according to an embodiment of the present invention. FIG. 5 is a flowchart showing the operation of the program control apparatus 10 according to the present embodiment.

In the operation of the program control apparatus 10, the tag reader 100 reads a tag ID of an ID tag existing around (in the detection range of) the tag reader 100 on a periodic basis or at every occurrence of a specific event, and the tag reader 100 sends the tag ID thus read, to the ID class determiner 12 of the program control apparatus 10 (S10).

When the ID class determiner 12 receives the tag ID, the ID class determiner 12 refers to the ID class database 18 stored in the storage 16, to determine whether the tag ID sent from the tag reader 100 is a service ID to specify a service, or an attribute ID to specify an attribute of an article (S12). In more detail, it performs a comparison process to compare the current input tag ID (or set of tag IDs) with a preceding input tag ID (or set of tag IDs) and, if the comparison with the preceding input tag ID results in detecting a new tag ID in the current input tag ID(s), the ID class determiner 12 refers to the ID class database 18 stored in the storage 16, using the tag ID as a key, to determine whether the tag ID is a service ID or an attribute ID. More specifically, where the preceding input tag ID is “000001” and where the current input tag IDs are “000001” and “100001,” the ID class determiner 12 determines whether the newly detected tag ID “100001” is a service ID or an attribute ID.

For example, where the tag reader 100 reads the tag ID “000001” of the ID tag 102 attached to the garbage box 104 and feeds the tag ID to the ID class determiner 12, the ID class determiner 12 refers to the ID class database 18, using the tag ID as a key, to determine that the tag ID is a service ID. Similarly, where the tag reader 100 reads the tag ID “100001” of the ID tag 106 attached to the sheet of paper 108 and feeds the tag ID to the ID class determiner 12, the ID class determiner 12 refers to the ID class database 18, using the tag ID as a key, to determine that the tag ID is an attribute ID. Likewise, where the tag reader 100 reads the tag ID “100002” of the ID tag 110 attached to the empty can 112 and feeds the tag ID to the ID class determiner 12, the ID class determiner 12 refers to the ID class database 18, using the tag ID as a key, to determine that the tag ID is an attribute ID. The result of the determination by the ID class determiner 12 is transmitted to the program controller 14.

When the ID class determiner 12 determines that a tag ID read by the tag reader 100 is a service ID, the program controller 14 refers to the program database 20 stored in the storage 16, and the program controller 14 runs a program associated with the service ID (S14).

For example, in the case where the tag reader 100 reads the tag ID “000001” of the ID tag 102 attached to the garbage box 104 and where the ID class determiner 12 determines that the tag ID is a service ID, the program controller 14 refers to the program database 20 stored in the storage 16, using the service ID as a key, retrieves from the storage 24 the “garbage separation program” associated with the service ID “000001,” and runs the “garbage separation program” thus retrieved. Here the “garbage separation program” receives input from the outside on a periodic basis or at every occurrence of a specific event during the running thereof.

On the other hand, when the ID class determiner 12 determines that a tag ID read by the tag reader 100 is an attribute ID, the program controller 14 refers to the attribute database 22 stored in the storage 16, and the program controller 14 notifies a running program of attribute information associated with the attribute ID (S16). As a result, the behavior of the running program is changed according to the attribute information notified of by the program controller 14 (S18).

For example, where during the running of the “garbage separation program” the tag reader 100 reads the tag ID “100001” of the ID tag 106 attached to the sheet of paper 108 and where the ID class determiner 12 determines that the tag ID is an attribute ID, the program controller 14 first refers to the attribute database 22 stored in the storage 16, using the attribute ID as a key, to retrieve the attribute information “paper” associated with the attribute ID “100001.” Subsequently, the program controller 14 notifies the running “garbage separation program” of the attribute information “paper” to change the behavior of the running “garbage separation program.” Namely, when the running “garbage separation program” receives the input of the attribute information “paper” from the outside, it performs the voice information output process of outputting “Thank you for your cooperation in collection of garbage by type” and the transmission process of transmitting the control signal for opening of the lid, to the automatic lid opening/closing mechanism provided in the garbage box (“permission process” shown in FIG. 5).

Where during the running of the “garbage separation program” the tag reader 100 reads the tag ID “100002” of the ID tag 110 attached to the empty can 112 and where the ID class determiner 12 determines that the tag ID is an attribute ID, the program controller 14 refers to the attribute database 22 stored in the storage 16, using the attribute ID as a key, to retrieve the attribute information “metal” associated with the attribute ID “100002.” Subsequently, the program controller 14 notifies the running “garbage separation program” of the attribute information “metal” to change the behavior of the running “garbage separation program.” Namely, when the running “garbage separation program” receives the input of the attribute information “metal” from the outside, it performs the voice information output process of outputting “This garbage box is available for paper only” and the transmission process of transmitting the control signal for closing of the lid, to the automatic lid opening/closing mechanism provided in the garbage box (“warning process” shown in FIG. 5).

Subsequently, the action and effect of the program control apparatus according to the present embodiment will be described. The program control apparatus 10 of the present embodiment is configured to determine whether a tag ID read by the tag reader 100 is a service ID to specify a service, or an attribute ID to specify an attribute of an article, to, when the tag ID is determined to be a service ID, run a program associated with the service ID, and to, when the tag ID is determined to be an attribute ID, notify a running program of attribute information associated with the attribute ID, to change the behavior of the running program according to the attribute information. Therefore, for example, when the surrounding circumstances vary around the tag reader 100, e.g., when a sheet of paper 108 is about to be put into the garbage box 102, or when an empty can 112 is about to be put into the garbage box 102, the behavior of the running program can be changed according to the attribute information of the tag ID read as a result by the tag reader. In consequence, it becomes feasible to perform flexible program control according to variation in surrounding circumstances, by use of ID tags.

In the program control apparatus 10 of the present embodiment, the ID class determiner 12 refers to the ID class database 18 to determine whether a tag ID read by the tag reader is a service ID or an attribute ID. Therefore, it becomes easier to perform the determination on whether a service ID or an attribute ID, and the management.

In the program control apparatus 10 of the present embodiment, the program controller 14 refers to the program database 20 to run a program associated with the service ID. Therefore, it becomes easier to select a program to be run.

In the program control apparatus 10 of the present embodiment, the program controller 14 refers to the attribute database 22 to notify the running program of the attribute information associated with the attribute ID to change the behavior of the program according to the attribute information. Therefore, it becomes feasible to readily change the relationship between the attribute information and the behavior of the program. Namely, if it is desired to modify the way of changing the behavior in changing the behavior of the running program (e.g., the “garbage separation program”) according to the attribute of a specific object (e.g., empty can 112) (for example, if it is desired to modify the mode of the running “garbage separation program” now performing the warning process according to the attribute of “metal” for the empty can 112, into a mode of performing the permission process for the empty can 112 as well), how to change the behavior of the running program can be modified by simply modifying the relationship between the attribute ID and the attribute in the attribute database 20 (for example, by changing the attribute associated with the attribute ID 100002, into “paper” in the attribute database 22), without need for attaching a new ID tag with an attribute ID associated with the other attribute (e.g., “paper”), to the object. In consequence, the versatility of program control is enhanced.

In the program control apparatus 10 of the above embodiment, the ID class determiner 12 refers to the ID class database 18 to determine whether a tag ID is a service ID or an attribute ID. However, this can also be implemented by adopting another determination technique. For example, a tag ID is preliminarily generated according to a specific rule, and the ID class determiner 12 determines whether a tag ID is a service ID or an attribute ID, based on the rule. For example, a tag ID is generated according to such a rule that the tag ID is a service ID if the highest bit of bit information developed from the tag ID is “0” and that the tag ID is an attribute ID if the highest bit is “1,” and the ID class determiner 12 determines whether the highest bit of bit information developed from a tag ID is “1” or “0,” thereby determining whether the tag ID is a service ID or an attribute ID.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A program control apparatus comprising:
ID class determining means for determining whether a tag ID read by a tag reader is a service ID to specify a service, or an attribute ID to specify an attribute of an article; and
program controlling means for, when the ID class determining means determines that the tag ID read by the tag reader is a service ID, running a program associated with the service ID and for, when the ID class determining means determines that the tag ID read by the tag reader is an attribute ID, notifying a running program of attribute information associated with the attribute ID, to change behavior of the running program according to the attribute information.

2. The program control apparatus according to claim 1, further comprising an ID class database storing tag IDs and ID classes in association with each other,
wherein the ID class determining means refers to the ID class database to determine whether a tag ID read by the tag reader is a service ID to specify a service, or an attribute ID to specify an attribute of an article.

3. The program control apparatus according to claim 1, further comprising a program database storing service IDs and programs in association with each other,
wherein the program controlling means refers to the program database to run the program associated with the service ID.

4. The program control apparatus according to claim 1, further comprising an attribute database storing attribute IDs and attributes of articles in association with each other,
wherein the program controlling means refers to the attribute database to notify the running program of the attribute information associated with the attribute ID, to change the behavior of the program according to the attribute information.

5. A program control method comprising:
an ID class determining step wherein ID class determining means determines whether a tag ID read by a tag reader is a service ID to specify a service, or an attribute ID to specify an attribute of an article;
a program running step wherein, when it is determined in the ID class determining step that the tag ID read by the tag reader is a service ID, program controlling means runs a program associated with the service ID; and
a program behavior changing step wherein, when it is determined in the ID class determining step that the tag ID read by the tag reader is an attribute ID, the program controlling means notifies a running program of attribute information associated with the attribute ID, to change behavior of the running program according to the attribute information.
